(19) United States
(12) Patent Application Publication
(10) Pub. No.: US 2023/0358370 A1
(43) Pub. Date: Nov. 9, 2023

(54) IMPROVING COLOR RENDERING ACCURACY OF LED LIGHTING DEVICE BY ADDING MONOCHROMATIC LIGHT ELEMENTS

(71) Applicant: Optimum Semiconductor Technologies Inc., Tarrytown, NY (US)

(72) Inventors: Sabin Daniel Iancu, Pleasantville, NY (US); John Glossner, Nashua, NH (US); Samantha Murphy, Nashua, NH (US); Kristin Koehn, Nashua, NH (US)

(73) Assignee: Optimum Semiconductor Technologies Inc., Tarrytown, NY (US)

(21) Appl. No.: 17/790,799

(22) PCT Filed: Dec. 29, 2020
(86) PCT No.: PCT/US2020/067341

§ 371 Date: Jul. 5, 2022

Related U.S. Application Data
(60) Provisional application No. 62/957,450, filed on Jan. 6, 2020.

(51) Int. Cl. F21K 9/60; H05B 45/28

(52) U.S. Cl. CPC F21K 9/60; H05B 45/28; F21Y 2115/10

(57) ABSTRACT

A light-emitting diode (LED) lighting device includes a white light source characterized by a general color rendering index (CRI) value and a first color-specific CRI value, and one or more LED elements of a color light within a wavelength band, wherein a combined light source comprising the white light source and the one or more LED elements is characterized by the general CRI value and a second color-specific CRI value, and the second color-specific CRI value is greater than the first color-specific CRI value.

### CROSS-REFERENCE TO RELATED APPLICATIONS

This application claims priority benefit to U.S. Provisional Application No. 62/957,450 filed Jan. 6, 2020, the content of which is incorporated by reference in its entirety.

### TECHNICAL FIELD

The present disclosure relates to light emitting diode (LED) light sources, and in particular, to a system and method that improves color rendering accuracy of LED light sources by adding monochromatic light elements to the LED sources.

### BACKGROUND

As solid-state light sources, the LED light sources (referred to as “LEDs” hereinafter) offer many benefits including a long service time, low maintenance, energy efficiency, high brightness, low heat generation, and small form-factors. LEDs are available in a wide range of colors. White LEDs can be achieved by combining colored LED elements (e.g., red, green, and blue LEDs).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates fifteen test color samples used for calculating the color rendering index (CRI) value or the extended CRI value.

FIG. 2A depicts a color matching function in the CIE XYZ color space.

FIG. 2B depicts a color matching function in the CIE RGB color space.

FIG. 3 depicts the spectrum of a strong red test color sample (TCS9).

FIG. 4 illustrates an LED lighting system according to an implementation of the disclosure.

FIG. 5 is a block diagram illustrating a method for providing an LED lighting device with enhanced R9 according to an implementation of the disclosure.

### DETAILED DESCRIPTION

Color is the visual perception by a human observer towards an object. The visual perception may depend on many factors including the surface reflective property and the spectrum of the light shone on the surface. Thus, objects may appear to have different colors under different lighting conditions. The color of an object in this disclosure refers to the perceived color of the object when its surface reflects an ideal light from the white light source. When the white light source generates a white light that differs from the ideal light, the object may appear in a color that differs from the color of the object. Light bulbs (e.g., incandescent light bulbs, LED light bulbs, compact fluorescent light (CFL) bulbs) may be used indoor to serve as a white light source for objects in the room. The “white lights” generated by these light bulbs (i.e., non-ideal white light sources) may be associated with different spectrums deviated from that of the ideal white light. One quality metric associated with the white light source is its ability to truthfully reveal the colors of objects in the room. The fidelity of colors under a white light source is highly desirable in fields such as art museum, art restoration, and medical cares.

The natural light is deemed as one form of ideal light sources for revealing the colors of objects. Other white light sources are commonly compared to the natural light source or other ideal light sources in this regard. The color rendering index (CRI) is commonly used as a quantitative measurement of the ability of the white light source to reveal the colors of objects when compared with an ideal light source or a natural light source. The CRI value is within a range of [0, 100], where a high CRI value (e.g., 90 or above) indicates a high fidelity of color rendering by the white light source and a low CRI value (e.g., below 50) indicates a poor color rendering by the white light source.

Thus, the CRI value associated with a light source is an indicative measurement of the accuracy and fidelity of the object colors rendered under the light source. The color rendering refers to the effect of a light source on the color appearance of objects when compared to the color appearance under a reference light source (e.g., the natural light or an ideal light). The CRI value of a light source does not indicate the apparent color of the light source which is measured by the correlated color temperature (CCT).

The color temperature of a light source is the temperature at which an ideal black-body radiator that radiates a light of comparable hue to the light source. The black-body radiator appears black at room temperature. But when the black-body radiator is heated up to a certain temperature, the black-body radiator may exhibit a glow. For example, when heated up to 1500 degrees Kelvin (K), the black-body radiator may glow red; at 2700K, the black-body radiator may glow yellow; at 4200K, the black-body radiator may glow bright white; at 5500K, the black-body radiator may glow blue. In LED lightings, lighting elements with color temperature below 3000K are referred to as “warm,” and lights with color temperature above 5000K are referred to as “cold.” An LED light may contain one or more LED lighting elements of one or more color temperatures.

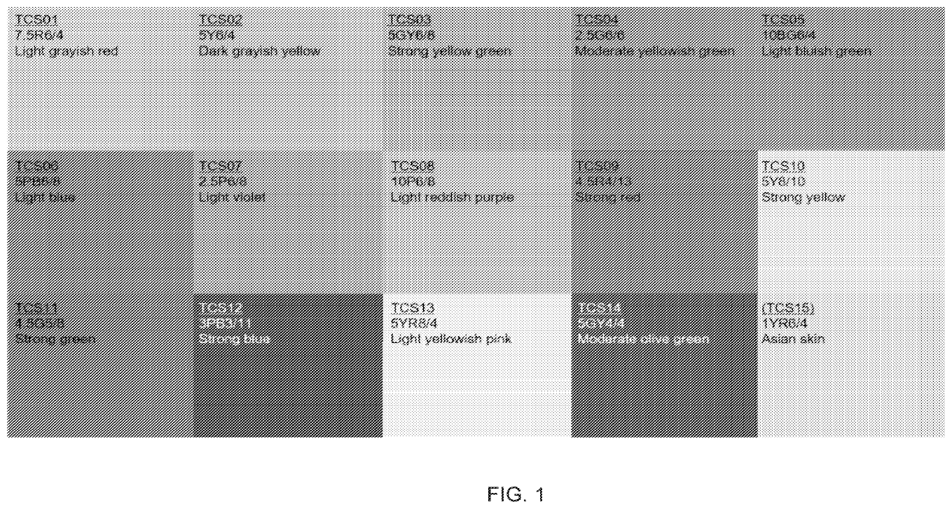

The CRI value of a light source is derived by testing the color rendering effects on a pre-determined set of test color samples by the light source. For each test color sample, the color rendering effect is measured as a score. The CRI value is calculated as an average of the scores on these test color samples. According to the International Commission on Illumination (CIE) protocol, eight (8) test color samples (referred to as TCS) are used for calculating the CRI value. Additional seven (7) supplemental test color samples can be used to calculate an extended CRI(e) value. FIG. 1 illustrates fifteen test color samples used for calculating the CRI value or the extended CRI value. The color rendering effects of first eight TCS (TCS01-TCS08) under the light source are measured correspondingly as R₁-R₈. The general CRI value (Rₐ) is the average of R₁-R₈.

While the CRI value Ra may reflect the color rendering ability of the light source to a certain extent, Rₐ does not fully reflect its color rendering ability with respect to colors other than TCS01-TCS08. The extended test color samples (TCS09-TCS15) include some of the colors that are useful in applications but are not represented by the CRI value Rₐ. These colors can be difficult to render faithfully under a white light source. In particular, R₉ is the measurement of the color rendering ability of a white light source towards “strong red” color (TCS09) which may require faithful color rendering in the settings such as filming, video, museum art lighting, textile printing, image printing, skin tone, and medical lighting. Additionally, many other objects which are not in the red color, but actually consist of different colors including the red color as a component. For example, the skin tone can be impacted by the blood vessels under the skin, which means that the skin tone also includes the red color although it looks much closer to white or light yellow. So, if the R₉ value is not high enough, the skin tone under this light will be pale or even greenish both visually and in photographs. Therefore, there is a need for technical solutions that improve the CRI R₉ value associated with a light source or lighting device.

The calculation of Rₐ may include testing each color sample under the light source to determine the corresponding Rᵢ, i=1, . . . , 8. One way to perform the test using the color sample may include the following:
1) using the 2° standard observer to determine the chromaticity coordinates of the light source in the CIE 1960 color space;
2) determining the correlated color temperature (CCT) of the light source by finding the closest point to the Planckian locus on the (u, v) chromaticity diagram, where Planckian locus (or black-body locus) is the path that the color of an incandescent black-body would take in a particular chromaticity space as the black-body temperature changes;
3) determining a reference light source based on the CCT of the light source. The reference light source is a black-body if CCT<5000K. Otherwise, the reference light source is the natural day light.
4) determining that the chromaticity distance (DC) between the light source and the reference light source is no more than 5.4×10⁻³ in the CIE 1960 color space to ensure that the light source is approximately white;
5) illuminating the color sample using the light source and the reference light source;
6) using the 2° standard observer to determine a first coordinates in the CIE 1964 color space for the reflected lights reflected by the color sample emitted from the light source and a second coordinate for reflected light emitted from the reference light source;
7) chromatically adapting the first and second coordinates in the CIE 1964 color space using von Kries transform;
8) calculating the Euclidean distance ΔEᵢ between the first and the second coordinates after the von Kries transform, where i=1, . . . 15 is an index value representing a particular test color sample;
9) calculating Rᵢ=100−4.6ΔEᵢ;
10) determining the CRI value (e.g., Rₐ) based on the average of Rᵢ.

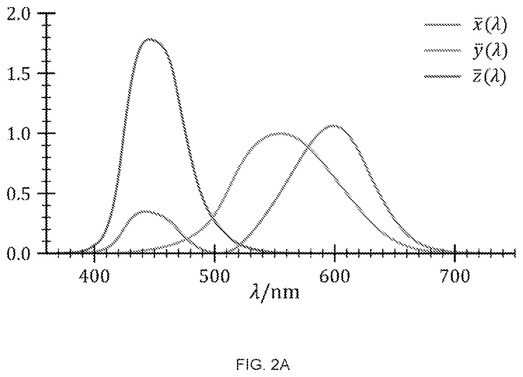

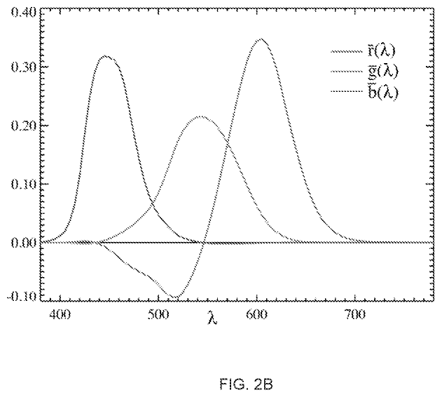

The standard observer (also referred to as the standard colorimetric observer) is a color mapping function defined in CIE that represents an average human's chromatic response within a 2° arc of the fovea of the human eyes. The standard observer may eliminate the influences caused by the observer's field of view. The standard observer may be characterized by three color matching functions which are the numerical description of the chromatic responses of the observer. The color matching functions represent the spectral sensitivity curves of three linear light detectors producing the CIE tristimulus values X, Y, and Z as shown in FIG. 2A. The color matching functions can be defined in the CIE RGB space (or other RGB color spaces). FIG. 2B shows color matching functions in the CIE RGB color space. As shown in FIG. 2B, the red color matching function may include negative values.

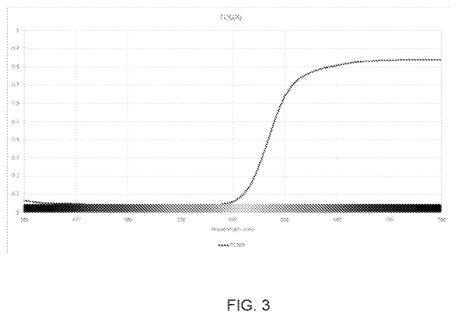

In practice, it is observed that white LED lightings do not render R₉ relating to strong red color truthfully. Generally, the R₉ component in the extended CRI value is relatively low compared to R₁-R₈, thus resulting a lower extended CRI value. Further, the spectrum of TCS9 is shown in FIG. 3. As shown in FIG. 3, while TCS9 is primarily concerned with spectral reflectance around 600 nm and above, there are also green and yellow components. This suggests that strengthening the green spectrum and/or a color with a wavelength close to the green spectrum may improve the R₉ score value, thus the rendering of strong red color. Implementations of the disclosure have shown that the addition of LED elements of a color light within a wavelength band (e.g., falling in the bands of green or close to green) to a white LED light source may significantly improve the R₉ value without much negative impacts on the CRI value Rₐ. In this way, implementations of the disclosure may achieve rendering of the strong red color or the similar with fidelity.

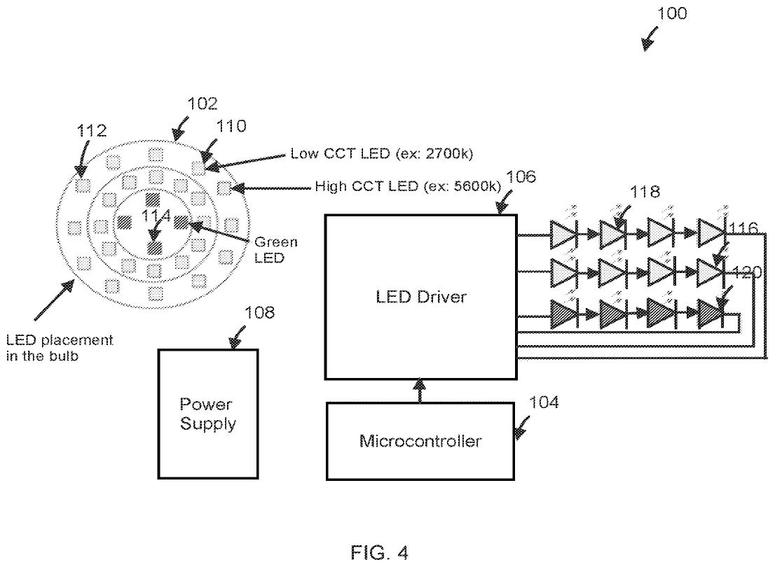

FIG. 4 illustrates an LED lighting system 100 according to an implementation of the disclosure. As shown in FIG. 4, LED light system 100 may include an LED lighting device 102, a microcontroller 104, an LED driver circuit 106, and a power supply 108. Power supply 108 can be an AC or DC power supply that provides the electrical power to LED lighting device 102, microcontroller 104, LED driver circuit 106. Microcontroller 104 can be a programmable controller circuit that controls the operation of LED lighting system 100. For example, the microcontroller 104 may include a dimmer circuit that controls the on/off, and the brightness of LED lighting device 102. LED driver circuit 106 may regulate the electrical currents supplied to LED lighting device 102 to forms that are suitable for operating LED lighting device 102.

LED lighting device 102 can be an LED light bulb used in different scenarios to provide the indoor/outdoor lighting. LED lighting device 102 may include one or more low-CCT (warm) LED elements 110 (e.g., emitting light around 2700K) and/or one or more high-CCT (cool) LED elements 112 (e.g., emitting light around 6500K). Any one or combination of low-CCT LED elements 110 and high-CCT LED elements 112 may constitute a white lighting source with a CRI value Rₐ. The light source including only low-CCT LED elements 110 and high-CCT LED elements 112 may be associated with R₉ score indicating the color rendering relating to the strong red color sample.

In one implementation, to improve the R₉ score while substantially maintaining the CRI value Rₐ associated with LED lighting device 102, LED lighting device 102 may be further provided with one or more LED elements 114 (e.g., green or a color close to green, referred to as green elements herein for the convenience of description). In one implementation, the LED elements 114 can be green LED with a peak spectrum around 505 nm. The addition of the one or more green LED elements 114 may increase the CRI value associated LED lighting device 102 from R₉ to R₉′ while substantially maintaining Rₐ unchanged. Here, R₉′ when the LED lighting device incorporating green elements 114 is greater than R₉ when the LED lighting device without green elements 114. For example, in one implementation, the addition of green LED elements 114 may cause the R₉ score associated with LED lighting device 102 to increase from around 50 to a value in the range of [99, 100] while maintaining the CRI value (Rₐ) associated with LED lighting device 102 at around 98. To support the operation of LED lighting device 102 as shown in FIG. 4, LED driver circuit 106 may include current regulation circuit 116 for low-CCT LED elements 110, current regulation circuit 118 for high-CCT LED elements 112, and current regulation circuit 120 for green LED elements 114. Microcontroller 104 may selectively turn on/off any one of current regulation circuits 116, 118, 120, thus enabling/disabling any one of LED elements 110, 112, 114. For example, to incorporating the green LED elements 114, LED driver circuit 106 may turn on the current regulation circuit 120 to supply power to these green LED elements.

Positioning of low-CCT LED elements 110, high-CCT LED elements 112, and green LED elements 114 can be any suitable arrangements that produce sufficient light. These LED elements can be arranged on a plane 2D surface or a curved 3D surface. Green LED elements 114 may include one or more elements arranged on a circular platform separate from low-CCT LED elements 110 and high-CCT LED elements 112. Alternatively, green LED elements 114 may be interspersed with low-CCT LED elements 110 and high-CCT LED elements 112.

Implementation of the disclosure may include an LED lighting device comprising at least one of low-CCT LED elements or high-CCT LED elements, where the at least one of low-CCT LED elements or high-CCT LED elements form a first white light source associated with a CRI value Rₐ and a first R₉ score value representing a red color rendering parameter. The LED lighting device further comprises green LED elements emitting a green light at a wavelength in a range of (450 nm, 600 nm) and preferably within a range of (480 nm, 550 nm), where the combination of the green LED elements and the at least one of low-CCT LED elements or high-CCT LED elements form a second white light source associated with the CRI value Rₐ and a second R₉ score value that is greater than the first R₉ score value.

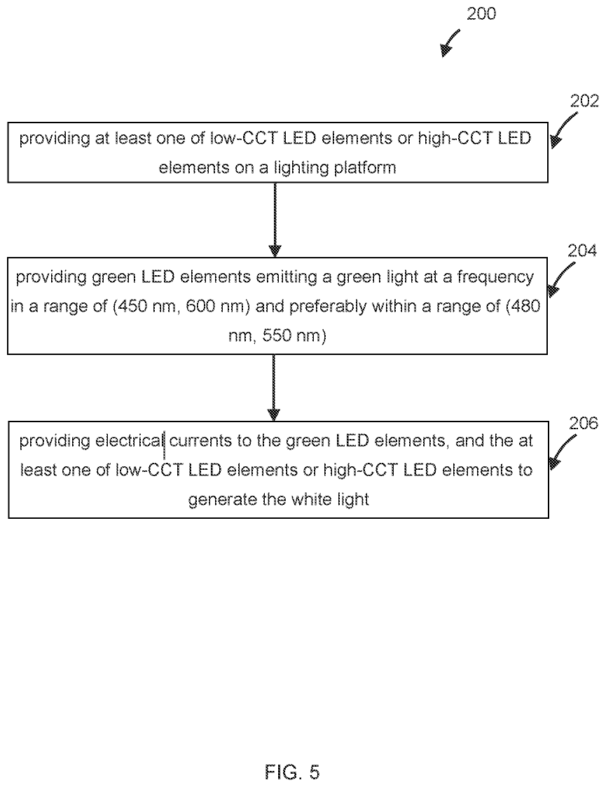

FIG. 5 is a block diagram illustrating a method 200 for manufacturing an LED lighting device with enhanced R₉ according to an implementation of the disclosure. Referring to FIG. 5, at 202, the method may include providing at least one of low-CCT LED elements or high-CCT LED elements on a lighting platform, where the at least one of low-CCT LED elements or high-CCT LED elements form a first white light source associated with a CRI value Rₐ and a first R₉ score value representing a red color rendering parameter.

At 204, the method may include providing green LED elements emitting a green light at a frequency in a range of (450 nm, 600 nm) and preferably within a range of (480 nm, 550 nm), where the combination of the green LED elements and the at least one of low-CCT LED elements or high-CCT LED elements form a second white light source associated with the CRI value Rₐ and a second R₉ score value that is greater than the first R₉ score value.

At 206, the method may include providing electrical currents to the green LED elements, and the at least one of low-CCT LED elements or high-CCT LED elements to generate the white light.

Implementations of the disclosure include a light-emitting diode (LED) lighting device including a white light source characterized by a general color rendering index (CRI) value and a first color-specific CRI value, and one or more LED elements of a color light within a wavelength band, wherein a combined light source comprising the white light source and the one or more LED elements is characterized by the general CRI value and a second color-specific CRI value, and the second color-specific CRI value is greater than the first color-specific CRI value.

Further, implementation of the disclosure include a method for LED light including providing at least one of low-CCT LED elements or high-CCT LED elements on a platform, wherein the at least one of low-CCT LED elements or high-CCT LED elements form a white light source characterized by a general color rendering index (CRI) value and a first color-specific CRI value, providing one or more LED elements of a color light within a wavelength band, wherein a combined light source comprising the white light source and the one or more LED elements is characterized by the general CRI value and a second color-specific CRI value, and the second color-specific CRI value is greater than the first color-specific CRI value, and providing electrical currents to the one or more green LED elements, and the at least one of low-CCT LED elements or high-CCT LED elements to generate a white light.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A light-emitting diode (LED) lighting device, comprising:
a white light source characterized by a general color rendering index (CRI) value and a first color-specific CRI value; and
one or more LED elements of a color light within a wavelength band, wherein a combined light source comprising the white light source and the one or more LED elements is characterized by the general CRI value and a second color-specific CRI value, and the second color-specific CRI value is greater than the first color-specific CRI value.

2. The LED lighting device of claim 1, wherein the white light source comprises at least one of high-temperature LED elements or low-temperature LED elements, and a combination of the at least one of high-temperature LED elements or low-temperature LED elements is characterized by the general CRI value and the first color-specific CRI value, the high-temperature LED elements emitting light lower than 3000K, and the low-temperature LED elements emitting light higher than 5000K.

3. The LED lighting device of claim 1, wherein the general CRI value represents an average of color rendering abilities of a light source for first eight test color samples (TCS) under International Commission on Illumination (CIE) protocol, the first eight TCS comprising light grayish red (TCS01), dark grayish yellow (TCS02), strong yellow green (TCS03), moderate yellowish green (TCS04), light bluish green (TCS05), light blue (TCS06), light violet (TCS07), and light reddish purple (TCS08), wherein the color-specific CRI value represents color rendering ability of a light source for a strong red TCS (TCS09) under the CIE protocol.

4. The LED lighting device of claim 1, wherein the one or more LED elements emit a green light with a wavelength in a range between 450 nm and 600 nm.

5. The LED lighting device of claim 4, wherein the one or more LED elements emit a green light with a wavelength in a range between 480 nm and 550 nm with a spectrum peak at 505 nm.

6. The LED lighting device of claim 2, wherein the one or more LED elements are arranged at a center of the LED lighting device surrounded by the at least one of high-temperature LED elements or low-temperature LED elements.

7. The LED lighting device of claim 2, wherein the one or more LED elements are interspersed with the at least one of high-temperature LED elements or low-temperature LED elements.

8. The LED lighting device of claim 1, wherein the one or more LED elements are arranged on one of a linear platform or a curved platform.

9. The LED lighting device of claim 1, wherein the combined light source comprising the white light source and the one or more LED elements of the color light within the wavelength band is characterized by a same general CRI value as that of the white light source but characterized by a greater color-specific CRI value than that of the white light source, wherein the color-specific CRI value is specific to a strong red color, and the color light within the wavelength band is other than the strong red color.

10. A lighting system, comprising:
a power supply;
a microcontroller;
a driver circuit;
current regulation circuits; and
the LED lighting device according to claims 1 through 10,
wherein the power supply provides an electrical power to the microcontroller, the driver circuit, the current regulation circuits, and the LED lighting device through the driver circuit and the current regulation circuits, and wherein the microcontroller is to control on and off of the lighting system, the LED driver circuit and the current regulation circuits provide regulated currents to the white light source and the one or more LED elements, respectively.

11. A method, comprising:
providing at least one of low-CCT LED elements or high-CCT LED elements on a platform, wherein the at least one of low-CCT LED elements or high-CCT LED elements form a white light source characterized by a general color rendering index (CRI) value and a first color-specific CRI value;
providing one or more LED elements of a color light within a wavelength band, wherein a combined light source comprising the white light source and the one or more LED elements is characterized by the general CRI value and a second color-specific CRI value, and the second color-specific CRI value is greater than the first color-specific CRI value; and
providing electrical currents to the one or more green LED elements, and the at least one of low-CCT LED elements or high-CCT LED elements to generate a white light.

12. The method of claim 11, wherein the low-CCT LED elements emitting light lower than 3000K, and the high-CCT LED elements emitting light higher than 5000K.

13. The method of claim 11, wherein the general CRI value represents an average of color rendering abilities of a light source for first eight test color samples (TCS) under International Commission on Illumination (CIE) protocol, the first eight TCS comprising light grayish red (TCS01), dark grayish yellow (TCS02), strong yellow green (TCS03), moderate yellowish green (TCS04), light bluish green (TCS05), light blue (TCS06), light violet (TCS07), and light reddish purple (TCS08), wherein the color-specific CRI value represents color rendering ability of a light source for a strong red TCS (TCS09) under the CIE protocol.

14. The method of claim 11, wherein the one or more LED elements emit a green light with a wavelength in a range between 450 nm and 600 nm.

15. The method of claim 14, wherein the one or more LED elements emit a green light with a wavelength in a range between 480 nm and 550 nm with a spectrum peak at 505 nm.

16. The method of claim 11, wherein the one or more LED elements are arranged at a center of the LED lighting device surrounded by the at least one of low-CCT LED elements or high-CCT LED elements.

17. The method of claim 1, wherein the one or more LED elements are interspersed with the at least one of low-CCT LED elements or high-CCT LED elements.

18. The method of claim 11, wherein the platform is one of a linear platform or a curved platform.

19. The method of claim 11, wherein the combined light source is characterized by a same general CRI value as that of the white light source but characterized by a greater color-specific CRI value than that of the white light source, wherein the color-specific CRI value is specific to a strong red color, and the color light within the wavelength band is other than the strong red color.
